(19) United States
(12) Patent Application Publication
(10) Pub. No.: US 2015/0063175 A1
(43) Pub. Date: Mar. 5, 2015

(54) WIRELESS COMMUNICATION APPARATUS

(71) Applicant: Kabushiki Kaisha Toshiba, Tokyo (JP)

(72) Inventors: Yoshiaki Yoshihara, Yokohama-Shi (JP); Ryuichi Fujimoto, Tokyo (JP)

(73) Assignee: Kabushiki Kaisha Toshiba, Tokyo (JP)

(21) Appl. No.: 14/180,968

(22) Filed: Feb. 14, 2014

(30) Foreign Application Priority Data
Aug. 28, 2013 (JP) 2013-177057

(51) Int. Cl. H04B 1/04; H04L 7/00; H04B 1/40

(52) U.S. Cl. CPC H04B 1/0475; H04B 1/40; H04L 7/0008
USPC 370/278; 455/114.1; 455/73

(57) ABSTRACT

According to an embodiment, a wireless communication apparatus includes a clock transmitting unit, a function circuit and a control unit. The clock transmitting unit is configured to transmit a clock signal through one of a plurality of transmission paths. The transmission paths are different from each other. The function circuit is configured to operate in synchronization with the clock signal transmitted by the clock transmitting unit. The control unit is configured to select one of the plurality of transmission paths according to an operation state of the wireless communication apparatus.

### CROSS REFERENCE TO RELATED APPLICATION

This application is based upon and claims the benefit of priority from the prior Japanese Patent Application No. 2013-177057 filed on Aug. 28, 2013 in Japan, the entire contents of which are incorporated herein by reference.

### FIELD

Embodiments described herein relate generally to a wireless communication apparatus.

### BACKGROUND

A wireless communication apparatus operates based on various clock signals. A clock signal includes a plurality of harmonic components since a waveform of the clock signal has a rectangular wave shape. These harmonic components leak into an antenna terminal of a receiving unit to which a reception signal is inputted. Hence, when a high order harmonic component of the clock signal overlaps a frequency component of a reception signal and, when a signal intensity of the harmonic component is strong at an antenna terminal, receiving sensitivity deteriorates.

### BRIEF DESCRIPTION OF THE DRAWINGS

FIG. 1 is a block diagram illustrating a schematic configuration of a wireless communication apparatus according to a first embodiment.

FIG. 2 is a view illustrating the frequency component of the reception signal and the harmonic components of the clock signal at the antenna terminal of the wireless communication apparatus according to the first embodiment.

FIG. 3 is a block diagram illustrating a schematic configuration of a wireless communication apparatus according to a first comparative example.

FIG. 4 is a view illustrating a frequency component of a reception signal and a harmonic component of the clock signal at an antenna terminal of the wireless communication apparatus according to the first comparative example.

FIG. 5 is a block diagram of the clock transmitting unit according to the modified example of the first embodiment.

FIG. 6 is a block diagram illustrating a schematic configuration of a wireless communication apparatus according to the second embodiment.

FIG. 7A is a view illustrating a frequency component of the local signal of the wireless communication apparatus according to the second embodiment.

FIG. 7B is a view illustrating a frequency component of the transmission signal.

FIG. 8 is a block diagram illustrating a schematic configuration of a wireless communication apparatus according to the third embodiment.

FIG. 9 is a waveform diagram of the adjusted clock signal of the wireless communication apparatus according to the third embodiment.

FIG. 10 is a view illustrating an example of harmonic components of the adjusted clock signal according to the third embodiment.

FIG. 11 is a view illustrating another example of harmonic components of the adjusted clock signal according to the third embodiment.

FIG. 12 is a view illustrating the frequency component of the reception signal and the harmonic components of the adjusted clock signal at the antenna terminal of the wireless communication apparatus according to the third embodiment.

FIG. 13 is a waveform diagram of the adjusted clock signal of the wireless communication apparatus according to the fourth embodiment.

FIG. 14A is a view illustrating an example of harmonic components of the adjusted clock signal according to the fourth embodiment.

FIG. 14B is an enlarged view of FIG. 14A.

FIG. 15 is a view illustrating the frequency component of the reception signal and the harmonic components of the adjusted clock signal at the antenna terminal of the wireless communication apparatus according to the fourth embodiment.

FIG. 16 is a block diagram illustrating a schematic configuration of a wireless communication apparatus according to the fifth embodiment.

FIG. 17 is a view illustrating the frequency component of the reception signal, a spurious component before cancellation and a spurious component after cancellation, at the antenna terminal of the wireless communication apparatus according to the fifth embodiment.

FIG. 18 is a block diagram illustrating a schematic configuration of the wireless communication apparatus according to the second comparative example.

### DETAILED DESCRIPTION

According to an embodiment, a wireless communication apparatus includes a clock transmitting unit, a function circuit and a control unit. The clock transmitting unit is configured to transmit a clock signal through one of a plurality of transmission paths. The transmission paths are different from each other. The function circuit is configured to operate in synchronization with the clock signal transmitted by the clock transmitting unit. The control unit is configured to select one of the plurality of transmission paths according to an operation state of the wireless communication apparatus.

Hereinafter, embodiments of the present invention will be described with reference to the drawings. The embodiments do not limit the present invention.

### First Embodiment

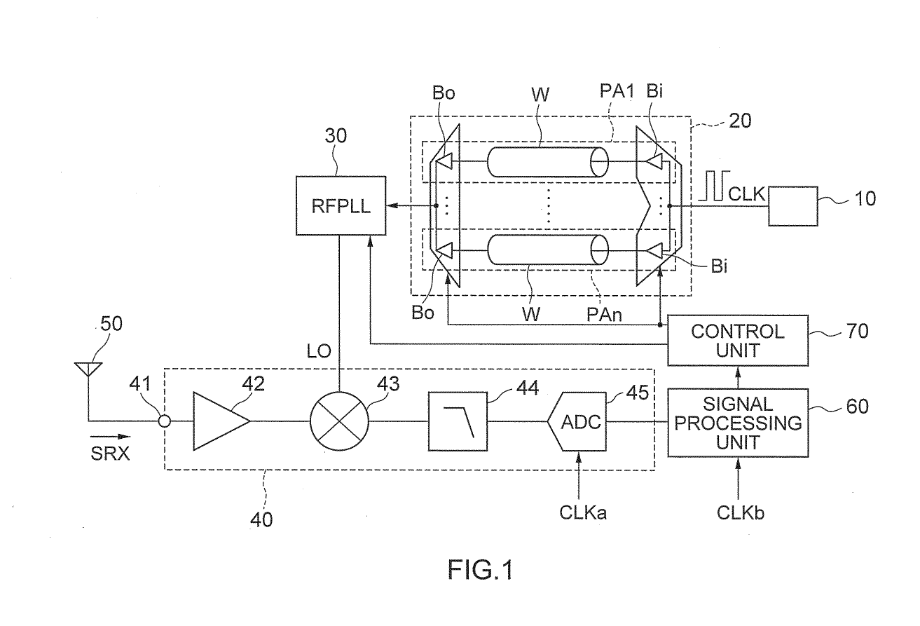

FIG. 1 is a block diagram illustrating a schematic configuration of a wireless communication apparatus according to a first embodiment. As illustrated in FIG. 1, the wireless communication apparatus has a clock generating unit 10, a clock transmitting unit 20, an RFPLL (a local signal generating unit, a function circuit) 30, a receiving unit 40, an antenna 50, a signal processing unit 60 and a control unit 70.

The clock generating unit 10 generates a clock signal CLK having a rectangular wave shape. The clock signal CLK includes a plurality of harmonics.

The clock transmitting unit 20 transmits the clock signal CLK supplied from the clock generating unit 10 through one of a plurality of transmission paths PA1 to PAn, the transmission paths PA1 to PAn being different from each other. That is, a plurality of transmission paths PA1 to PAn is provided such that a positional relationship between the transmission paths, and other components such as a power line and signal lines which are not illustrated and the receiving unit 40 is different. FIG. 1 illustrates the two transmission paths PA1 and PAn.

Each of the transmission paths PA1 to PAn has an input buffer Bi which buffers and outputs the clock signal CLK, a wire W which transmits an output signal of the input buffer Bi, and an output buffer Bo which buffers and outputs a signal transmitted through the wire W.

The RFPLL 30 which is the function circuit operates in synchronization with the clock signal CLK transmitted by the clock transmitting unit 20. More specifically, the RFPLL 30 generates a high frequency local signal LO based on the clock signal CLK.

The receiving unit 40 has an antenna terminal 41 which is connected to an antenna 50, and receives a reception signal SRX which is a radio signal through the antenna 50 and the antenna terminal 41. More specifically, the receiving unit 40 receives the reception signal SRX having a frequency corresponding to a frequency fLO of the local signal LO. In the present embodiment, the receiving unit 40 receives the reception signal SRX whose center frequency is the frequency fLO of the local signal LO. This center frequency is also referred to as a frequency fRX of the reception signal SRX. The reception signal SRX has a predetermined bandwidth matching a wireless communication standard.

The receiving unit 40 has an amplifier 42, a mixer 43, a filter 44 and an A/D converter 45.

The amplifier 42 amplifies the reception signal SRX.

The mixer 43 frequency-converts the reception signal SRX amplified by the amplifier 42 using the local signal LO to output as a low frequency signal having a frequency lower than the frequency of the reception signal SRX.

The filter 44 limits a band of the low frequency signal outputted from the mixer 43.

The A/D converter 45 converts the low frequency signal whose band is limited by the filter 44 into a digital signal. The A/D converter 45 operates in synchronization with a clock signal CLKa.

The signal processing unit 60 performs signal processing on the digital signal supplied from the A/D converter 45 to obtain reception data. The signal processing unit 60 operates in synchronization with a clock signal CLKb.

The control unit 70 selects one of a plurality of transmission paths PA1 to PAn according to an operation state of the wireless communication apparatus. More specifically, the control unit 70 selects a transmission path which minimizes a harmonic component of the clock signal CLK which overlaps the frequency component of the reception signal SRX at the antenna terminal 41 during reception. Further, the control unit 70 controls the RFPLL 30 to set the frequency fLO of the local signal LO, and selects a transmission path for each frequency fLO of the local signal LO. A method of selecting a transmission path will be described below.

The control unit 70 activates the input buffer Bi and the output buffer Bo of the selected transmission path, and does not activate the input buffers Bi and the output buffers Bo of the transmission paths which are not selected. Hence, harmonics of the clock signal CLK are not produced from the transmission paths which are not selected.

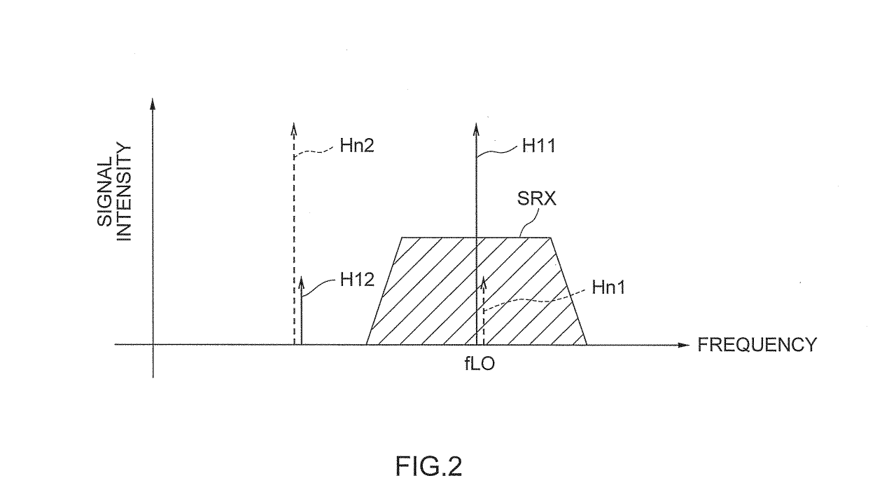

Next, an operation of the wireless communication apparatus will be described with reference to FIG. 2.

FIG. 2 is a view illustrating the frequency component of the reception signal SRX and the harmonic components of the clock signal CLK at the antenna terminal 41 of the wireless communication apparatus according to the first embodiment.

When the transmission path PA1 is selected, a plurality of harmonic components of the clock signal CLK transmitted through the transmission path PA1 leaks into the antenna terminal 41. As illustrated in FIG. 2, a signal intensity of a high order harmonic component H11, which overlaps the frequency component of the reception signal SRX, among a plurality of harmonic components leaked into the antenna terminal 41 is stronger than a signal intensity of the frequency component of the reception signal SRX. Further, for example, the signal intensity of the harmonic component H12 having a frequency lower than that of the harmonic component H11 is weaker than the signal intensity of the harmonic component H11.

Meanwhile, when the transmission path PAn is selected, a plurality of harmonic components of the clock signal CLK transmitted through the transmission path PAn leaks into the antenna terminal 41. However, as illustrated in FIG. 2, a signal intensity of a high order harmonic component Hn1, which overlaps the frequency component of the reception signal SRX, among a plurality of harmonic components leaked into the antenna terminal 41 is sufficiently weaker than the signal intensity of the frequency component of the reception signal SRX. Further, for example, the signal intensity of the harmonic component Hn2 having a frequency lower than that of the harmonic component Hn1 is stronger than the signal intensity of the harmonic component Hn1.

Hence, in this example, by selecting the transmission path PAn, the harmonic component Hn1 of the clock signal CLK influences the frequency component of the reception signal SRX little, so that it is possible to prevent deterioration of receiving sensitivity.

Further, as described above, by selecting a transmission path for each frequency fLO of the local signal LO, it is possible to select a transmission path, which minimizes the harmonic component of the clock signal CLK which overlaps the frequency component of the reception signal SRX at the antenna terminal 41, for each frequency of the reception signal SRX.

In addition, there are various paths through which the harmonic components of the clock signal CLK leak into the antenna terminal 41, and, for example, the harmonic components are likely to leak through a power line or signal lines in the wireless communication apparatus.

Next, a method of selecting an adequate transmission path will be described. For example, a transmission path may be selected after following calibration (1) or (2) is performed.

(1) Calibration in Case where there is No Reception Signal SRX

The signal processing unit 60 calculates a signal intensity at the antenna terminal 41 based on reception data for each transmission path PA1 to PAn when there is not the reception signal SRX outside the wireless communication apparatus, and performs transmission path specifying processing of specifying a transmission path in which the signal intensity is the lowest. Further, the signal processing unit 60 performs this transmission path specifying processing for each frequency fLO of the local signal LO.

(2) Calibration in Case where there is Reception Signal SRX

The signal processing unit 60 detects an easiness of reception of the reception signal SRX based on reception data for each transmission path PA1 to PAn when there is the reception signal SRX outside the wireless communication apparatus, and performs transmission path specifying processing of specifying a transmission path in which the reception of the reception signal is the easiest. Further, the signal processing unit 60 performs this transmission path specifying processing for each frequency fLO of the local signal LO. The easiness of reception of the reception signal SRX is, for example, receiving sensitivity.

For example, the calibration (1) or (2) may be performed when the wireless communication apparatus is powered on or shipped from a factory, and a result may be stored in, for example, a memory unit which is not illustrated. By this means, the control unit 70 can select an optimal transmission path for each frequency fLO of the local signal LO according to the result stored in, for example, the memory unit.

Thus, according to the present embodiment, since the clock signal CLK is transmitted through one of a plurality of different transmission paths PA1 to PAn, intensities of harmonic components of the clock signal CLK which appear at the antenna terminal 41 differ for each transmission path PA1 to PAn. Hence, by selecting a transmission path which minimizes the harmonic component which overlaps the frequency component of the reception signal SRX during reception, it is possible to prevent deterioration of receiving sensitivity.

That is, it is possible to prevent deterioration of wireless communication characteristics caused by the harmonics of the clock signal CLK.

In addition, although an example has been described where the clock signal CLK to be supplied to the RFPLL 30 is transmitted through one of the transmission paths PA1 to PAn, a clock signal (not illustrated) to be supplied to a PLL (the function circuit, not illustrated) which generates the low frequency clock signals CLKa and CLKb may be transmitted through one of a plurality of transmission paths. Further, when the harmonic component of the clock signal CLKa overlaps the frequency component of the reception signal SRX at the antenna terminal 41, the clock signal CLKa may be transmitted through one of a plurality of transmission paths. In this case, the A/D converter 45 functions as the function circuit. Further, when the harmonic component of the clock signal CLKb overlaps the frequency component of the reception signal SRX at the antenna terminal 41, the clock signal CLKb may be transmitted through one of a plurality of transmission paths. In this case, the signal processing unit 60 functions as the function circuit.

That is, a plurality of transmission paths may be provided not only for the above clock signals but also for other clock signals used in the wireless communication apparatus.

Further, if deterioration of receiving sensitivity of the reception signal SRX in a frequency range defined according to the wireless communication standard can be prevented, the control unit 70 may select one transmission path irrespectively of the frequency fLO of the local signal LO without selecting a transmission path for each frequency fLO of the local signal LO.

Furthermore, a repeater (not illustrated) may be provided in halfway on the wire W of each of the transmission paths PA1 to PAn. In this case, the control unit 70 activates the input buffer Bi, the repeater and the output buffer Bo of the selected transmission path, and does not activate the input buffers Bi, the repeaters and the output buffers Bo of the transmission paths which are not selected.

Further, the wireless communication apparatus may be configured such that a transmitting unit is provided to the configuration in FIG. 1 to support transmission and reception.

### First Comparative Example

Hereinafter, a wireless communication apparatus according to a first comparative example will be described.

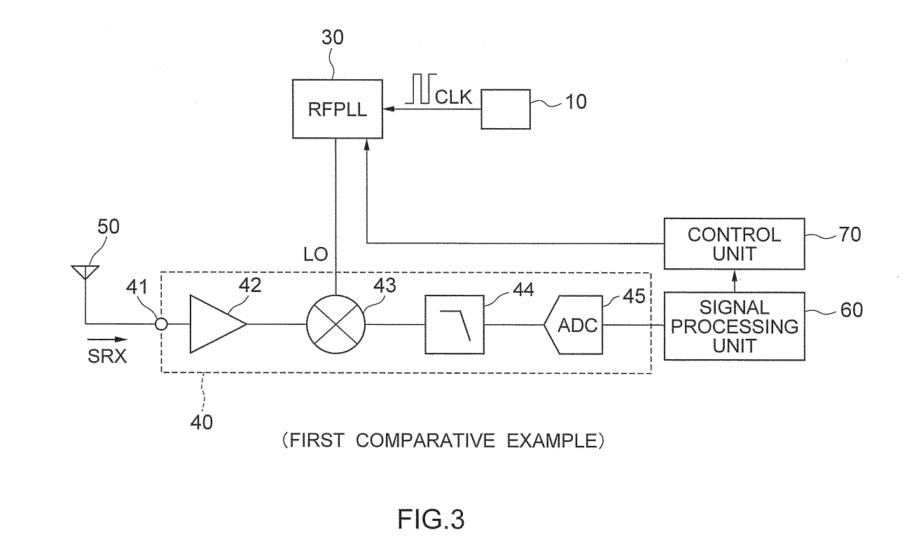

FIG. 3 is a block diagram illustrating a schematic configuration of a wireless communication apparatus according to a first comparative example. As illustrated in FIG. 3, this wireless communication apparatus differs from the first embodiment in not including a clock transmitting unit 20, that is, a plurality of transmission paths PA1 to PAn. That is, a clock signal CLK is transmitted to an RFPLL 30 through one predetermined transmission path. The other circuit configurations are the same as those of the first embodiment in FIG. 1, and therefore the same elements will be assigned the same reference numerals and will not be described.

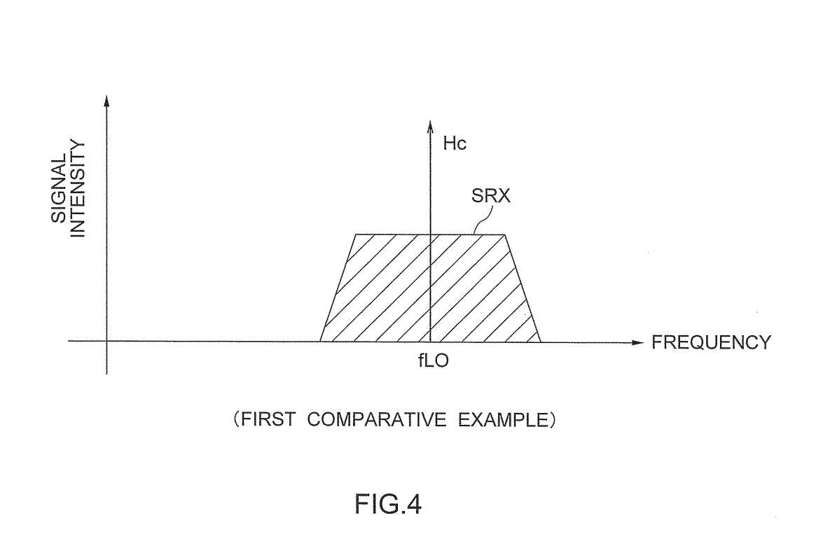

FIG. 4 is a view illustrating a frequency component of a reception signal SRX and a harmonic component of the clock signal CLK at an antenna terminal 41 of the wireless communication apparatus according to the first comparative example.

A plurality of harmonic components of the clock signal CLK leaks into the antenna terminal 41. As illustrated in FIG. 4, a signal intensity of a high order harmonic component He which overlaps the frequency component of the reception signal SRX is stronger than a signal intensity of the frequency component of the reception signal SRX. Therefore, receiving sensitivity deteriorates.

### Modified Example of First Embodiment

Each of transmission paths PA1 to PAn of a clock transmitting unit 20 may be configured using switches instead of buffers.

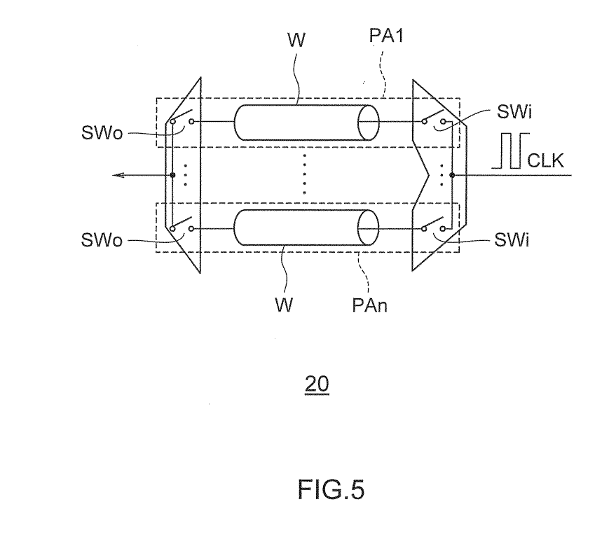

FIG. 5 is a block diagram of the clock transmitting unit 20 according to the modified example of the first embodiment. As illustrated in FIG. 5, each of the transmission paths PA1 to PAn has an input switch SWi, the clock signal CLK being supplied to one end of the input switch SWi, a wire W, one end of the wire W being connected to the other end of the input switch SWi, and an output switch SWo, one end of the output switch SWo being connected to the other end of the wire W, and the other end of the output switch SWo outputting the clock signal CLK transmitted through the wire W during conduction.

The control unit 70 conducts the input switch SWi and the output switch SWo of the selected transmission path, and does not conduct the input switches SWi and the output switches SWo of the transmission paths which are not selected.

Even the configuration illustrated in FIG. 5 can provide the same effect as that in the first embodiment.

### Second Embodiment

The second embodiment differs from the first embodiment in transmitting a clock signal CLK through different transmission paths during reception and during transmission.

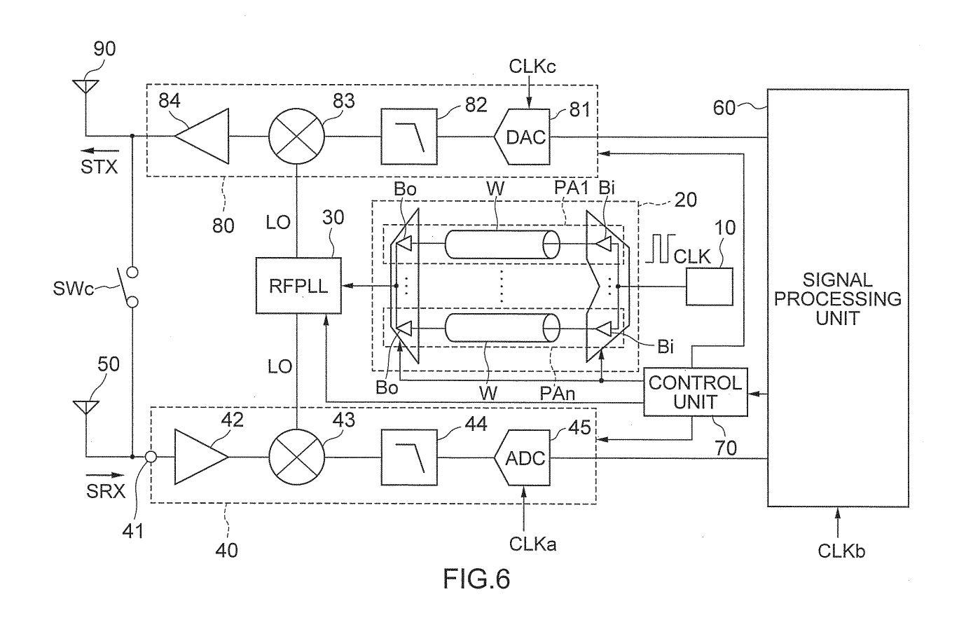

FIG. 6 is a block diagram illustrating a schematic configuration of a wireless communication apparatus according to the second embodiment. As illustrated in FIG. 6, the wireless communication apparatus has a transmitting unit 80, an antenna 90 and a switch SWc in addition to the configuration of the first embodiment in FIG. 1. The other circuit configurations are the same as those of the first embodiment in FIG. 1, and therefore the same elements will be assigned the same reference numerals and will not be described.

Similar to the first embodiment, a receiving unit 40 receives a reception signal SRX having a frequency corresponding to a frequency fLO of a local signal LO during reception.

The transmitting unit 80 transmits a transmission signal STX having a frequency corresponding to the frequency fLO of the local signal LO. In the present embodiment, the transmitting unit 80 transmits the transmission signal STX whose center frequency (transmission frequency) is the frequency fLO of the local signal LO. The transmission signal STX has a predetermined bandwidth matching a wireless communication standard.

The transmitting unit 80 has a D/A converter 81, a filter 82, a mixer 83 and an amplifier 84.

A signal processing unit 60 outputs a digital signal obtained by performing signal processing on transmission data, and the D/A converter 81 converts this digital signal into an analog signal. The D/A converter 81 operates in synchronization with a clock signal CLKc.

The filter 82 limits a band of the analog signal outputted from the D/A converter 81.

The mixer 83 frequency-converts the analog signal whose band is limited by the filter 82 using the local signal LO to output as a high frequency signal.

The amplifier 84 supplies the transmission signal STX obtained by amplifying the high frequency signal, to the antenna 90.

The control unit 70 controls the transmitting unit 80, the receiving unit 40 and the RFPLL 30 to perform wireless communication using a TDD (Time Division Duplex) method.

The control unit 70 selects one of a plurality of transmission paths PA1 to PAn according to an operation state of the wireless communication apparatus. In the present embodiment, the control unit 70 selects transmission paths which are different in the transmission and the reception.

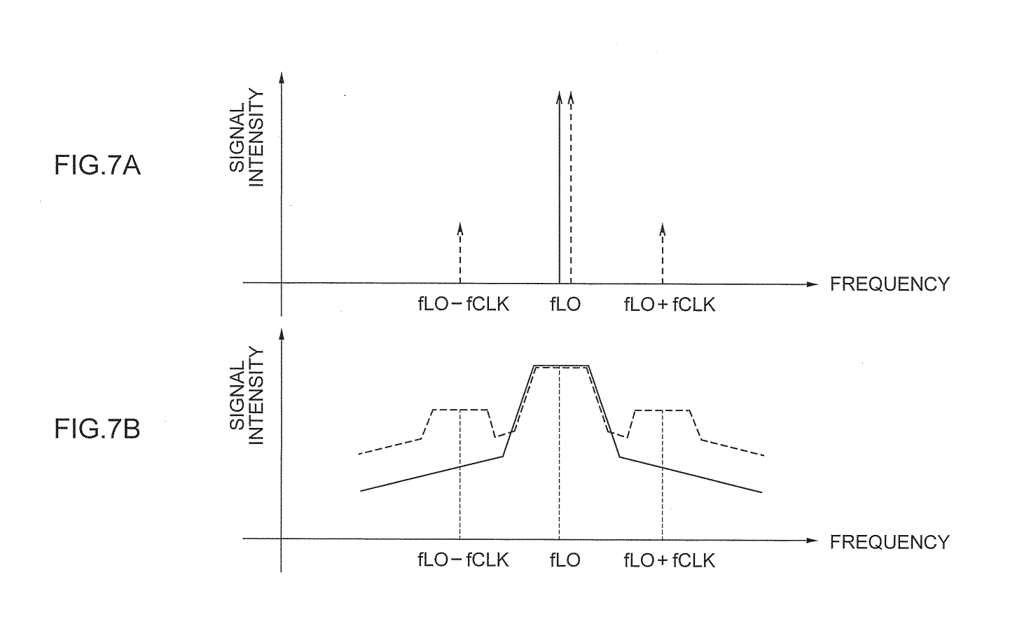

Next, an operation of the wireless communication apparatus during transmission will be described with reference to FIGS. 7A and 7B.

FIG. 7A is a view illustrating a frequency component of the local signal LO of the wireless communication apparatus according to the second embodiment, and FIG. 7B is a view illustrating a frequency component of the transmission signal STX.

When the transmission path PA1 is selected, the local signal LO includes only the frequency component having the frequency fLO in the illustrated frequency range as indicated by a solid line arrow in FIG. 7A. Hence, as indicated by a solid line in FIG. 7B, the transmission signal STX includes a frequency component having a predetermined bandwidth around the frequency fLO. In addition, FIGS. 7A and 7B illustrate only the vicinities of the frequency fLO.

Meanwhile, when the transmission path PAn is selected, as indicated by broken line arrows in FIG. 7A, the local signal LO includes the frequency component having the frequency fLO and, in addition, frequency components having the frequency fLO−fCLK and the frequency fLO+fCLK whose intensities are weaker than that of the frequency component having the frequency fLO. This occurs because the clock signal CLK leaks into a component of the RFPLL 30 and the clock signal CLK is mixed with the local signal LO.

Hence, as indicated by a broken line in FIG. 7B, the transmission signal STX includes a frequency component having a predetermined bandwidth around the frequency fLO and also includes an unnecessary frequency component having the predetermined bandwidth around the frequency fLO−fCLK and the frequency fLO+fCLK. The unnecessary frequency component becomes unnecessary radiation, and does not satisfy a communication standard (mask). Therefore, transmitting characteristics deteriorate.

Consequently, in this example, by selecting the transmission path PA1 in which the clock signal CLK is hardly mixed with the local signal LO, it is possible to prevent deterioration of transmission characteristics.

The operation during reception is the same as that in the first embodiment and therefore will not be described in detail. When, for example, the transmission path PAn which is different from that during transmission is selected during reception, it is possible to prevent deterioration of receiving sensitivity similar to the first embodiment.

Next, a method of selecting an adequate transmission path during transmission will be described. For example, a transmission path may be selected after the following calibration is performed.

The switch SWc is controlled to a conduction state during calibration, and can supply the transmission signal STX as the reception signal SRX to the receiving unit 40 (loop-back). While calibration is not performed, the switch SWc is controlled to a non-conduction state.

The signal processing unit 60 detects intensities of the unnecessary frequency component of the reception signal SRX based on reception data for each transmission path PA1 to PAn while the switch SWc is conducted, and performs transmission path specifying processing of specifying a transmission path in which the intensity of the unnecessary frequency component is the lowest. As described above, the unnecessary frequency component is a component around the frequency fLO of the local signal LO±the frequency fCLK of the clock signal CLK. The transmission path specifying processing only needs to be performed once using the local signal LO of an arbitrary frequency.

For example, the calibration may be performed when the wireless communication apparatus is powered on or shipped from a factory, and a result may be stored in, for example, a memory unit which is not illustrated. By this means, the control unit 70 can select an optimal transmission path during transmission according to the result stored in, for example, the memory unit.

Further, the transmission signal STX may be measured using an external measuring apparatus when shipping from a factory without providing the switch SWc, the intensity of an unnecessary frequency component may be obtained for each transmission path PA1 to PAn, and transmission path specifying processing of specifying a transmission path in which the intensity of the unnecessary frequency component is the lowest may be performed. Furthermore, a result may be stored in, for example, the memory which is not illustrated.

As described above, according to the present embodiment, the clock signal CLK is transmitted through one of a plurality of different transmission paths PA1 to PAn and different transmission paths are used during reception and during transmission, so that it is possible to select optimal transmission paths during transmission and during reception.

That is, it is possible to select a transmission path which minimizes the harmonic component which overlaps the frequency component of the reception signal SRX. Consequently, it is possible to prevent deterioration of receiving sensitivity.

Meanwhile, by selecting a transmission path in which the clock signal CLK is hardly mixed with the local signal LO by the RFPLL 30, it is possible to prevent an unnecessary frequency component caused by the clock signal CLK from appearing in the transmission signal SIX. Consequently, it is possible to prevent deterioration of transmission characteristics.

That is, it is possible to prevent deterioration of wireless communication characteristics caused by the harmonics of the clock signal CLK.

### Third Embodiment

One of features of the third embodiment lies in adjusting a rising time tr and a falling time tf of a clock signal CLK to times represented by a reciprocal of a predetermined frequency.

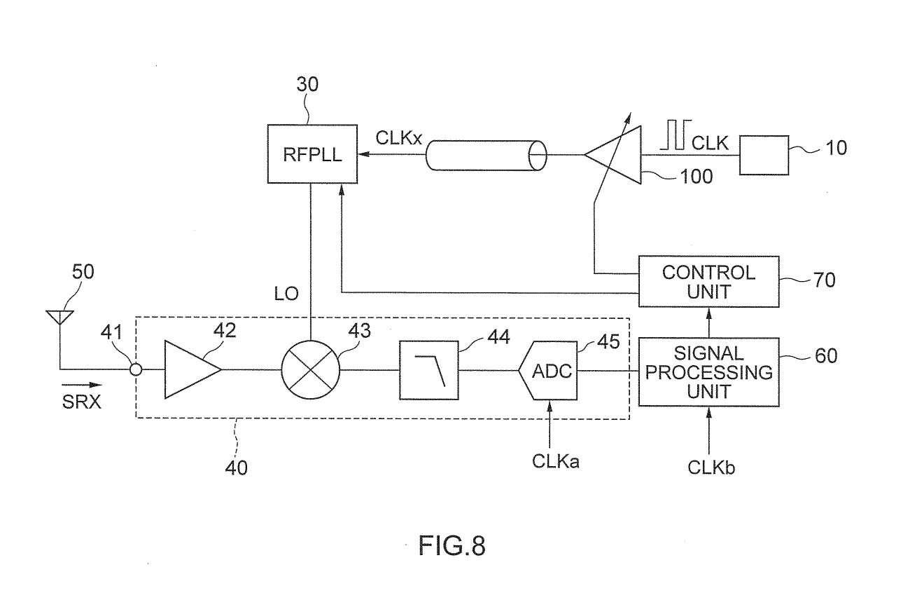

FIG. 8 is a block diagram illustrating a schematic configuration of a wireless communication apparatus according to the third embodiment. As illustrated in FIG. 8, the wireless communication apparatus has a clock adjusting unit 100 instead of a clock transmitting unit 20 according to the first embodiment. The other circuit configurations are the same as those of the first embodiment in FIG. 1, and therefore the same elements will be assigned the same reference numerals and will not be described.

The clock adjusting unit 100 generates an adjusted clock signal CLKx obtained by adjusting the rising time tr and the falling time tf of the supplied clock signal CLK to a time represented by a reciprocal of a predetermined frequency.

An RFPLL 30 operates in synchronization with the adjusted clock signal CLKx in the same way as in the first embodiment. More specifically, the RFPLL 30 generates a local signal LO based on the adjusted clock signal CLKx.

Similar to the first embodiment, the receiving unit 40 receives a reception signal SRX whose center frequency is a frequency fLO of the local signal LO.

The control unit 70 controls the RFPLL 30 to set the frequency fLO of the local signal LO, and controls the clock adjusting unit 100 to set the predetermined frequency equal to the frequency fLO of the local signal LO. That is, in the present embodiment, the predetermined frequency is equal to a frequency fRX of the reception signal SRX.

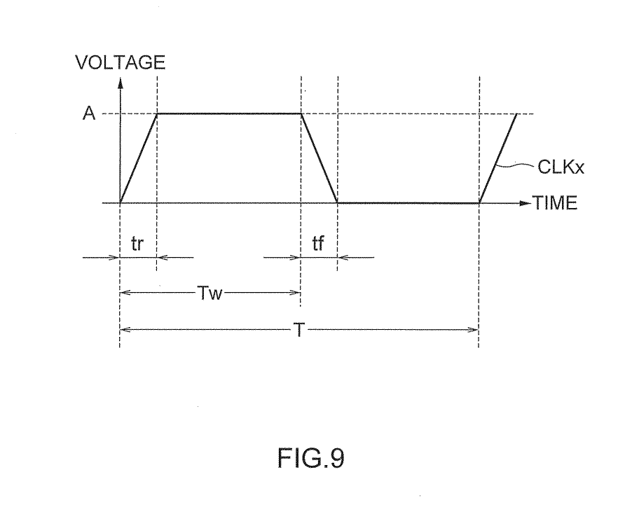

FIG. 9 is a waveform diagram of the adjusted clock signal CLKx of the wireless communication apparatus according to the third embodiment. As illustrated in FIG. 9, a rising time of the adjusted clock signal CLKx is tr, a falling time is tf, the frequency is fCLK, a cycle is T, a ½ cycle is Tw, an amplitude is A and a duty ratio is 50%.

A frequency component of the adjusted clock signal CLKx in the case where tr=tf and Tw=T/2=½fCLK is represented by the following equation.

$$\begin{matrix}\vert X ( f ) \vert = A \frac{{T}_{W}}{T} \cdot \frac{sin ( π {T}_{W} f )}{π {T}_{W} f} \cdot \frac{sin ( π {t}_{r} f )}{π {t}_{r} f} \\ = \frac{A}{2} \cdot sin c ( π \frac{f}{2 {f}_{CLK}} ) \cdot sin c ( π {t}_{r} f )\end{matrix}$$

Hence, in the case where tr=1/fRX, sinc(πtrf)=0 is obtained when f=fRX, a frequency component having the frequency fRX of the reception signal SRX is eliminated from the adjusted clock signal CLKx.

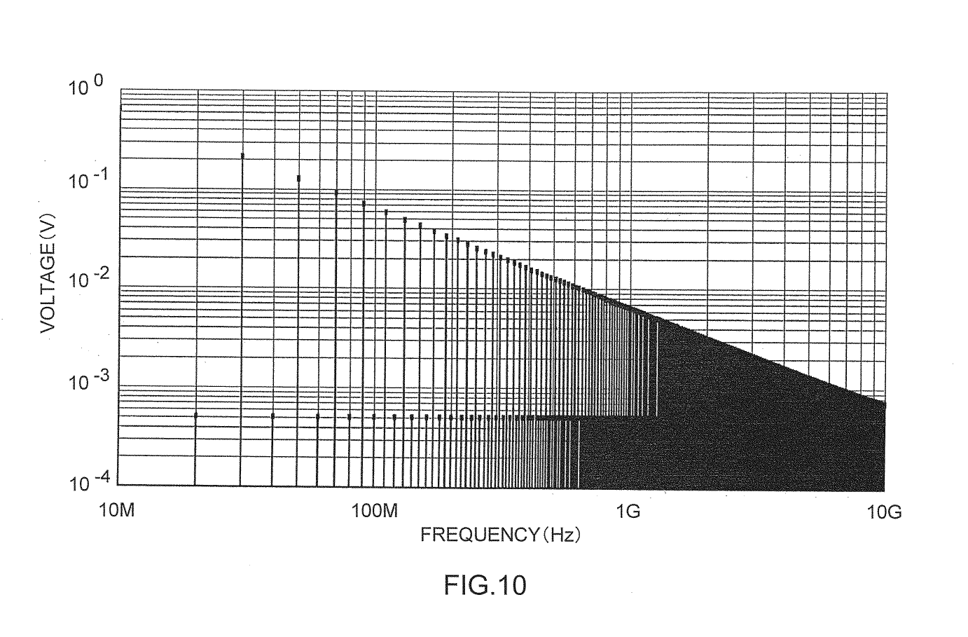

FIG. 10 is a view illustrating an example of harmonic components of the adjusted clock signal CLKx according to the third embodiment. Meanwhile, the predetermined frequency is 1000 GHz. That is, rising time tr=falling time tf=1 ps is obtained. The frequency fCLK of the adjusted clock signal CLKx is 10 MHz.

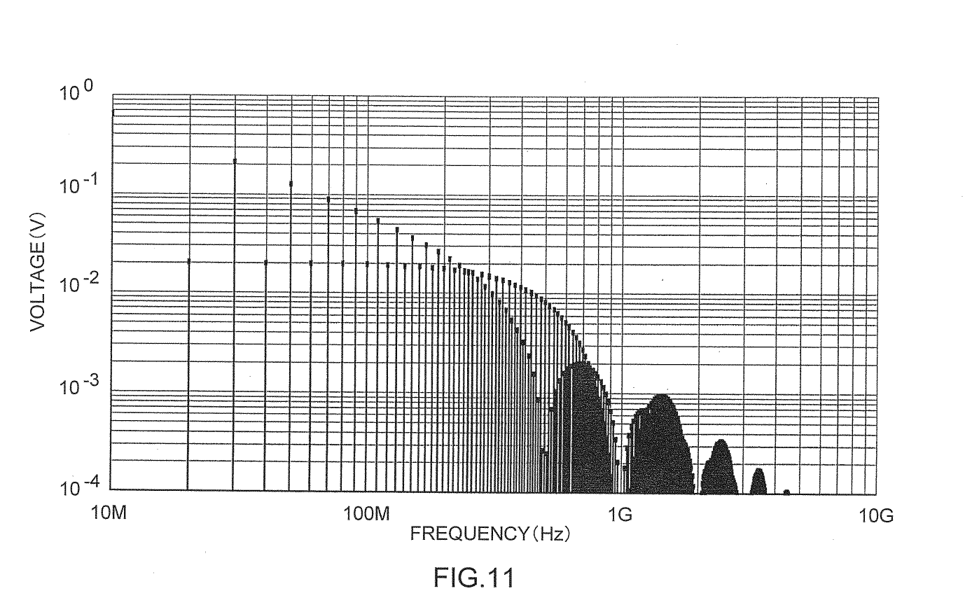

FIG. 11 is a view illustrating another example of harmonic components of the adjusted clock signal CLKx according to the third embodiment. Meanwhile, the predetermined frequency is 1 GHz. That is, rising time tr=falling time tf=1 ns is obtained. The frequency fCLK of the adjusted clock signal CLKx is 10 MHz. Vertical axes in FIGS. 10 and 11 represent the voltage as a logarithm, and horizontal axes represent the frequency as a logarithm.

When the rising time tr and the falling time tf are short as illustrated in FIG. 10, the harmonic component near 1 GHz is about 7×10⁻³ V. Further, the harmonic component monotonically decreases according to an increase in the frequency.

Meanwhile, when the rising time tr and the falling time tf are adjusted to the times (1 ns) represented by a reciprocal of a predetermined frequency (1 GHz) as illustrated in FIG. 11, harmonic components near 1 GHz decrease in a notch shape, and the minimum harmonic component decreases to below about 1×10⁻⁴ V. Further, the harmonic components in 1 GHz or more also decrease more than those in the example in FIG. 11.

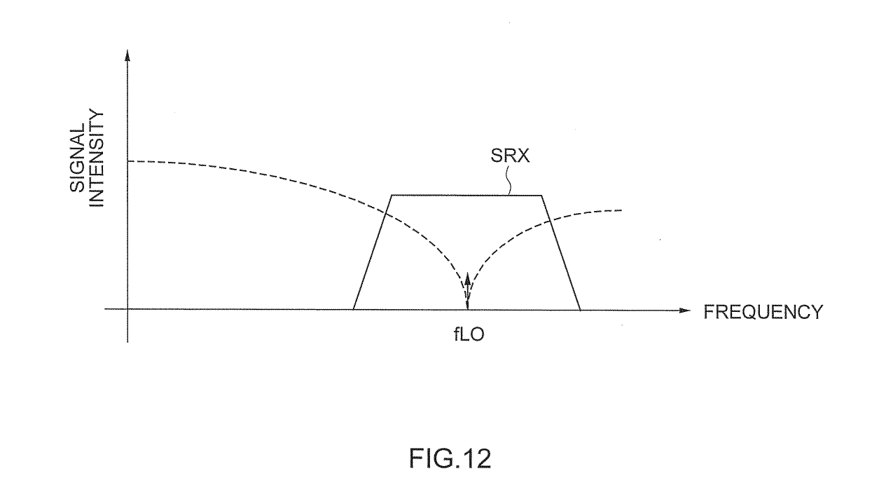

FIG. 12 is a view illustrating the frequency component of the reception signal SRX and the harmonic components of the adjusted clock signal CLKx at the antenna terminal 41 of the wireless communication apparatus according to the third embodiment. FIG. 12 illustrates a broken line connecting maximum values of a plurality of harmonic components of the adjusted clock signal CLKx.

As illustrated in FIG. 12, a plurality of harmonic components of the adjusted clock signal CLKx leaks into the antenna terminal 41. However, similar to the example in FIG. 11, the harmonic components leaked into the antenna terminal 41 decrease in a notch shape at the frequency fRX (frequency fLO) of the reception signal SRX. Hence, the signal intensity of the harmonic component which overlaps the reception signal SRX is weaker than the signal intensity of the frequency component of the reception signal SRX.

Thus, according to the present embodiment, the adjusted clock signal CLKx obtained by adjusting the rising time tr and the falling time tf of the clock signal CLK to times represented by a reciprocal of a predetermined frequency is generated, so that it is possible to reduce harmonics of the predetermined frequency and near the predetermined frequency of the adjusted clock signal CLKx. The predetermined frequency is equal to the frequency fRX of the reception signal SRX, so that it is possible to reduce a harmonic component which overlaps the frequency component of the reception signal SRX at the antenna terminal 41 of the receiving unit 40. Consequently, it is possible to prevent deterioration of receiving sensitivity.

Further, the predetermined frequency is set equal to the frequency fLO of the local signal LO, so that it is possible to prevent deterioration of receiving sensitivity of a plurality of reception signals SRX whose frequencies are different from each other.

That is, it is possible to prevent deterioration of wireless communication characteristics caused by the harmonics of the clock signal CLK.

In addition, as illustrated in FIGS. 11 and 12, the harmonics near the predetermined frequency of the adjusted clock signal CLKx can also be reduced, so that the predetermined frequency may be not only equal to the frequency fRX of the reception signal SRX but near the frequency fRX of the reception signal SRX.

Further, the predetermined frequency may be set as a fixed value near the intermediate frequency between the maximum frequency and the minimum frequency of the reception signal SRX defined according to the wireless communication standard. Also in this case, the predetermined frequency is near the frequency fRX of the reception signal SRX. In this case, it is not necessary to control the predetermined frequency according to a change of the frequency SRX of the reception signal SRX and, consequently, it is possible to simplify the configuration of the control unit 70.

Further, the third embodiment may be combined with the first or second embodiment.

### Fourth Embodiment

The fourth embodiment differs from the third embodiment in adjusting a rising time tr and a falling time tf of a clock signal CLK to different times.

A wireless communication apparatus according to the fourth embodiment employs basically the same configuration as that of the third embodiment in FIG. 8, and only functions of a clock adjusting unit 100 and a control unit 70 are different from, those of the third embodiment. Hereinafter, differences from the third embodiment will be described.

The clock adjusting unit 100 generates an adjusted clock signal CLKx obtained by adjusting at least one of the rising time tr and the falling time tf of the supplied clock signal CLK.

The control unit 70 controls the clock adjusting unit 100 according to a frequency fRX of a reception signal SRX such that the rising time tr and the falling time tf are different or the rising time tr and the falling time tf are equal.

More specifically, when an odd order harmonic component of the clock signal CLK overlaps the frequency component of the reception signal SRX, the control unit 70 controls the clock adjusting unit 100 such that the rising time tr and the falling time tf are different.

When an even order harmonic component of the clock signal CLK overlaps the frequency component of the reception signal SRX, the control unit 70 controls the clock adjusting unit 100 such that the rising time tr and the falling time tf are equal.

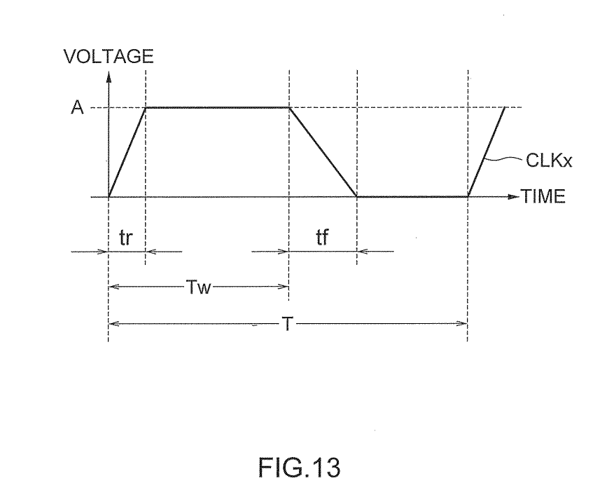

FIG. 13 is a waveform diagram of the adjusted clock signal CLKx of the wireless communication apparatus according to the fourth embodiment. Meanwhile, the rising time tr and the falling time tf are different.

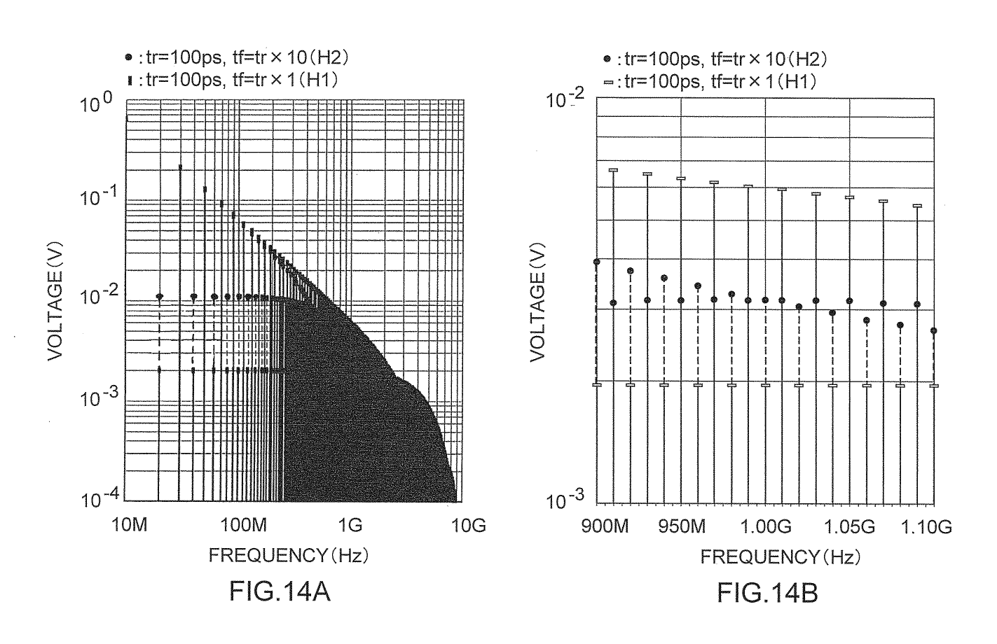

FIG. 14A is a view illustrating an example of harmonic components of the adjusted clock signal CLKx according to the fourth embodiment, and FIG. 14B is an enlarged view of FIG. 14A. FIG. 14B illustrates an enlarged range from 900 MHz to 1.1 GHz in FIG. 14A. Meanwhile, each figure illustrates a harmonic component H1 in the case where rising time tr=falling time tf=100 ps, and a harmonic component H2 in the case where rising time tr=100 ps and falling time tf=1000 ps. The frequency fCLK of the adjusted clock signal CLKx is 10 MHz.

As is clear from FIG. 14B, the harmonic component H1 near 1 GHz, when the rising time tr and the falling time tf are equal, includes the magnitude of the odd order harmonic component (such as 910 MHz or 930 MHz) which is about three times as the magnitude of the even order harmonic component (such as 900 MHz or 920 MHz).

Meanwhile, the harmonic component H2 when the rising time tr and the falling time tf are different includes a lowered odd order harmonic component and an increased even order harmonic component compared to the harmonic component H1.

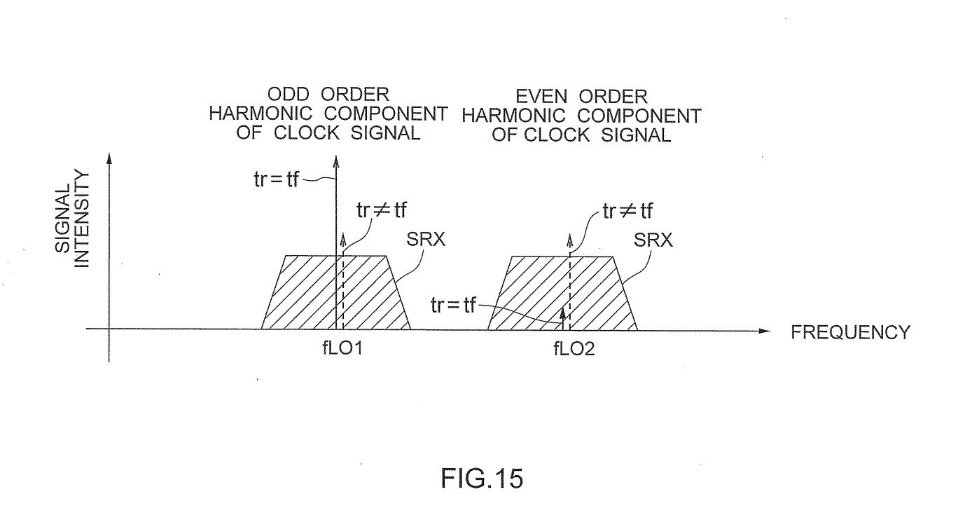

FIG. 15 is a view illustrating the frequency component of the reception signal SRX and the harmonic components of the adjusted clock signal CLKx at the antenna terminal 41 of the wireless communication apparatus according to the fourth embodiment.

A plurality of harmonic components of the adjusted clock signal CLKx leaks into the antenna terminal 41. Meanwhile, as illustrated in FIG. 15, when the frequency fRX of the reception signal SRX is fLO1, the odd order harmonic component overlaps the frequency component of the reception signal SRX. In this case, by setting the rising time tr and the falling time tf to different times, it is possible to reduce the odd order harmonic component compared to when the rising time tr and the falling time tf are equal. Consequently, it is possible to prevent deterioration of receiving sensitivity.

Meanwhile, when the frequency fRX of the reception signal SRX is fLO2 which is higher than fLO1, the even order harmonic component overlaps the frequency component of the reception signal SRX. In this case, by setting the rising time tr and the falling time tf equal, it is possible to reduce the even order harmonic component compared to when the rising time tr and the falling time if are different. Consequently, it is possible to prevent deterioration of receiving sensitivity.

As described above, according to the present embodiment, when the odd order harmonic component of the clock signal CLK overlaps the frequency component of the reception signal SRX, the rising time tr and the falling time tf are adjusted to different times, so that it is possible to reduce the odd order harmonic component of the adjusted clock signal CLKx. Consequently, it is possible to reduce the odd order harmonic component which leaks into the antenna terminal 41 of the receiving unit 40 and, consequently, prevent deterioration of receiving sensitivity.

Further, when the even order harmonic component of the clock signal CLK overlaps the frequency component of the reception signal SRX, the rising time tr and the falling time tf are adjusted to be equal, so that it is possible to reduce the even order harmonic component of the adjusted clock signal CLKx. Consequently, it is possible to reduce the even order harmonic component which leaks into the antenna terminal 41 of the receiving unit 40 and, consequently, prevent deterioration of receiving sensitivity.

That is, it is possible to prevent deterioration of wireless communication characteristics caused by the harmonics of the clock signal CLK.

In addition, the fourth embodiment may be combined with one of the first to third embodiments.

### Fifth Embodiment

One of features of the fifth embodiment is to cancel harmonic components of a clock signal CLK using a correction signal Sc generated based on the clock signal CLK.

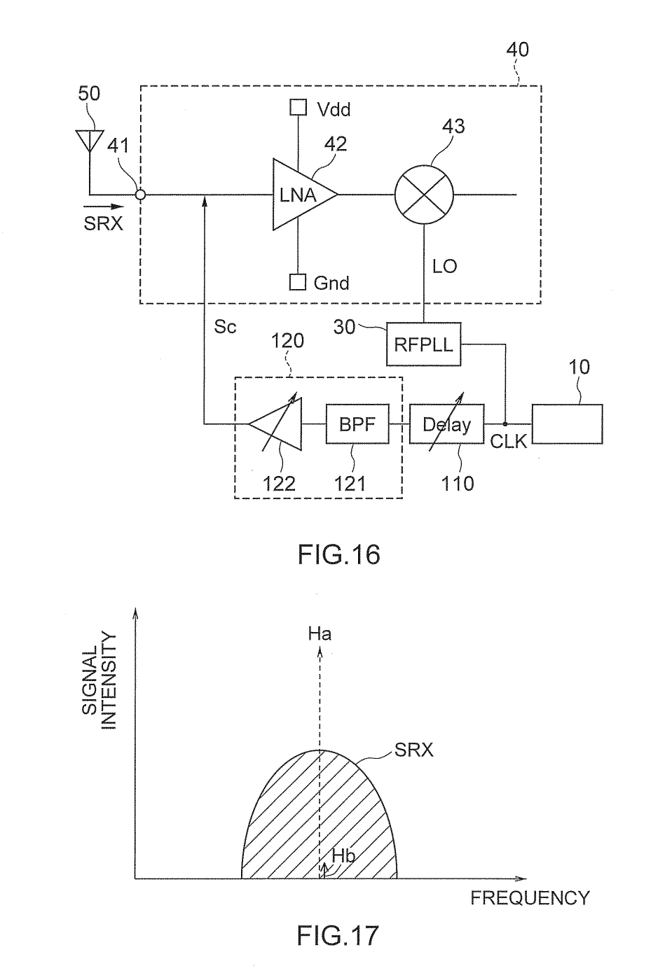

FIG. 16 is a block diagram illustrating a schematic configuration of a wireless communication apparatus according to the fifth embodiment. As illustrated in FIG. 16, the wireless communication apparatus differs from the first embodiment in FIG. 1 in not including a clock transmitting unit 20 and including a delay circuit 110 and a correction signal generating circuit 120. The other circuit configurations are the same as those in FIG. 1, and therefore the same elements will be assigned the same reference numerals and will not be described. In addition, a filter 44, an A/D converter 45, a signal processing unit 60 and a control unit 70 in FIG. 1 are not directly relevant to the features of the present embodiment, and therefore are not illustrated.

An RFPLL 30 which is the function circuit operates in synchronization with the clock signal CLK supplied from a clock generating unit 10. More specifically, the RFPLL 30 generates a high frequency local signal LO based on the clock signal CLK.

The delay circuit 110 delays the clock signal CLK supplied from the clock generating unit 10 by adjusting a delay time. The delay time can be adjusted by external control.

The correction signal generating circuit 120 adjusts an amplitude of a harmonic component (also referred to as a spurious component) of the clock signal CLK, which is included in the clock signal CLK delayed by the delay circuit 110 and which overlaps the frequency component of the reception signal SRX, to output as a correction signal Sc.

The correction signal Sc is supplied to an input or an output of an amplifier 42. In the illustrated example, the correction signal Sc is supplied to the input of the amplifier 42.

The correction signal generating circuit 120 has a filter 121 and a variable gain amplifier 122.

The filter 121 extracts the harmonic component of the clock signal CLK, which overlaps the frequency component of the reception signal SRX, from the clock signal CLK delayed by the delay circuit 110. The filter 121 is, for example, a bandpass filter.

The variable gain amplifier 122 can adjust the gain by way of external control, and adjusts the amplitude of the harmonic component of the clock signal CLK extracted by the filter 121 to output as the correction signal Sc.

Next, an operation of canceling a spurious component will be described.

As described in the first embodiment, the spurious component runs around the antenna terminal 41 through, for example, a power line.

When the delay circuit 110 adjusts the delay time of the clock signal CLK, for example, a phase of a 100th order harmonic component of the clock signal changes 100 times as the amount of the change of the phase of the clock signal CLK. Consequently, it is possible to achieve a significant phase change with a little delay time. The clock signal CLK is in, for example, a band of several MHz or a band of several tens of MHz and is a low frequency signal compared to the reception signal SRX, so that it is easy to adjust a delay time and it is possible to reduce a consumption current of the delay circuit 110.

Consequently, by adjusting the delay time to adjust the phase of the correction signal Sc to an inverse phase of the phase of the spurious component, and by adjusting the amplitude to adjust the amplitude of the correction signal Sc to the amplitude of the spurious component, it is possible to cancel (correct) the spurious component at the input of the amplifier 42.

Thus, in the present embodiment, using the clock signal CLK which is the original spurious source as seeds, the spurious component is canceled.

FIG. 17 is a view illustrating the frequency component of the reception signal SRX, a spurious component Ha before cancellation and a spurious component Hb after cancellation, at the antenna terminal 41 of the wireless communication apparatus according to the fifth embodiment.

Although the spurious component Ha before cancellation, that is, before the delay time and the amplitude are adjusted, is stronger than the frequency component of the reception signal SRX, there is little harmonic component Hb of the clock signal CLK after cancellation, that is, after the delay time and the amplitude are adjusted.

Thus, according to the present embodiment, the spurious component included in the delayed clock signal CLK is supplied as the correction signal Sc to the input of the amplifier 42 after adjusting the amplitude. By this means, it is possible to cancel the spurious component at the antenna terminal 41 by adjusting the delay time and the amplitude. Consequently, it is possible to prevent deterioration of receiving sensitivity.

That is, it is possible to prevent deterioration of wireless communication characteristics caused by the harmonics of the clock signal CLK.

In addition, it is also possible to provide the same effect by supplying the correction signal Sc to the output of the amplifier 42.

Further, although an example has been described above where the clock signal CLK used in the RFPLL 30 is delayed by the delay circuit 110, when another clock signal used in the wireless communication apparatus is a spurious source, another clock signal which is the spurious source may be delayed by the delay circuit 110.

Furthermore, although the order of the filter 121 and the variable gain amplifier 122 may be reversed, the above-described order is more preferable.

### Second Comparative Example

Hereinafter, a wireless communication apparatus according to a second comparative example which the inventors comprehend will be described in comparison with the fifth embodiment.

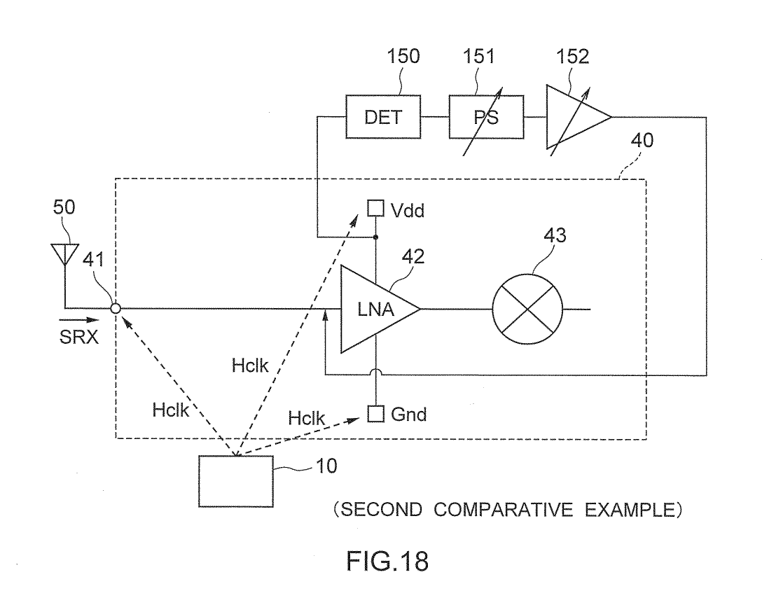

FIG. 18 is a block diagram illustrating a schematic configuration of the wireless communication apparatus according to the second comparative example. As illustrated in FIG. 18, this wireless communication apparatus differs from the fifth embodiment in not including a delay circuit 110 and a correction signal generating circuit 120 and including a detector 150, a phase shifter 151 and a variable gain amplifier 152. The other circuit configurations are the same as those of the fifth embodiment in FIG. 16, and therefore the same elements will be assigned the same reference numerals and will not be described.

Harmonic components Hclk of a clock signal CLK run around, for example, a power terminal Vdd and a ground terminal Gnd of an amplifier 42 and the antenna terminal 41 from a clock generating unit 10.

The detector 150 detects a harmonic component of the clock signal CLK which overlaps the frequency component of the reception signal SRX among the harmonic components Hclk, from the power terminal Vdd of the amplifier 42.

The phase shifter 151 adjusts the phase of the harmonic component of the clock signal CLK detected by the detector 150.

The variable gain amplifier 152 adjusts the amplitude of the harmonic component of the clock signal CLK whose phase is adjusted by the phase shifter 151, and supplies the obtained signal to the input or the output of the amplifier 42.

According to this configuration, principally, if it is possible to adjust the amplitude and the phase well, it is possible to cancel a spurious component. However, in reality, a frequency of a harmonic component whose phase is adjusted by the phase shifter 151 is a frequency (for example, several GHz) of the reception signal SRX and a weak analog signal, and therefore it is difficult to freely adjust the phase.

Therefore, unlike the fifth embodiment, it is difficult cancel a spurious component in the second comparative example.

In the wireless communication apparatuses according to the first to fifth embodiments, an entire circuit may be formed on a single semiconductor substrate or part of a circuit may be formed on another semiconductor substrate. Further, the wireless communication apparatuses according to the first to fifth embodiments may be mounted on a printed substrate using a discrete part.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless communication apparatus comprising:
a clock transmitting unit configured to transmit a clock signal through one of a plurality of transmission paths, the transmission paths being different from each other;
a function circuit configured to operate in synchronization with the clock signal transmitted by the clock transmitting unit; and
a control unit configured to select one of the plurality of transmission paths according to an operation state of the wireless communication apparatus.

2. The wireless communication apparatus of claim 1, further comprising a receiving unit configured to receive a reception signal through an antenna terminal,
wherein the control unit is configured to select a transmission path which minimizes a harmonic component of the clock signal, the harmonic component overlapping a frequency component of the reception signal at the antenna terminal.

3. The wireless communication apparatus of claim 2, wherein
the function circuit is a local signal generating unit configured to generate a local signal based on the clock signal transmitted by the clock transmitting unit, and
the receiving unit is configured to receive the reception signal having a frequency corresponding to a frequency of the local signal.

4. The wireless communication apparatus of claim 3, wherein the control unit is configured to control the local signal generating unit to set the frequency of the local signal, and select the transmission path for each frequency of the local signal.

5. The wireless communication apparatus of claim 4, wherein
the receiving unit is configured to convert a low frequency signal into a digital signal, the low frequency signal being obtained by frequency-converting the reception signal using the local signal,
the wireless communication apparatus further comprises a signal processing unit configured to perform signal processing on the digital signal to obtain reception data, calculate a signal intensity at the antenna terminal based on the reception data for each transmission path when there is not the reception signal outside the wireless communication apparatus, and perform transmission path specifying processing of specifying the transmission path in which the signal intensity is the lowest, for each frequency of the local signal, and
the control unit is configured to select the specified transmission path for each frequency of the local signal.

6. The wireless communication apparatus of claim 4, wherein
the receiving unit is configured to convert a low frequency signal into a digital signal, the low frequency signal being obtained by frequency-converting the reception signal using the local signal,
the wireless communication apparatus further comprises a signal processing unit configured to perform signal processing on the digital signal to obtain reception data, detect an easiness of reception of the reception signal based on the reception data for each transmission path when there is the reception signal outside the wireless communication apparatus, and perform transmission path specifying processing of specifying the transmission path in which the reception of the reception signal is the easiest, for each frequency of the local signal, and
the control unit is configured to select the specified transmission path for each frequency of the local signal.

7. The wireless communication apparatus of claim 6, wherein the easiness of the reception of the reception signal is receiving sensitivity.

8. The wireless communication apparatus of claim 1, further comprising:
a transmitting unit configured to transmit a transmission signal having a frequency corresponding to a frequency of a local signal, during transmission; and
a receiving unit configured to receive a reception signal having a frequency corresponding to the frequency of the local signal, during reception,
wherein the function circuit is a local signal generating unit configured to generate the local signal based on the clock signal transmitted by the clock transmitting unit, and
the control unit is configured to control the transmitting unit, the receiving unit and the local signal generating unit to perform wireless communication using a TDD method, and select transmission paths which are different in the transmission and the reception.

9. The wireless communication apparatus of claim 8, wherein
the receiving unit is configured to convert a low frequency signal into a digital signal, the low frequency signal being obtained by frequency-converting the reception signal using the local signal;
the wireless communication apparatus further comprises: a switch configured to be controlled to a conduction state and supply the transmission signal to the receiving unit as the reception signal, during calibration,
a signal processing unit configured to perform signal processing on the digital signal to obtain reception data, detect an intensity of an unnecessary frequency component in the reception signal based on the reception data for each transmission path while the switch is conducted, and perform transmission path specifying processing of specifying the transmission path in which the intensity of the unnecessary frequency component is the lowest, and
the control unit is configured to select the specified transmission path during the transmission.

10. The wireless communication apparatus of claim 9, wherein the unnecessary frequency component comprises a component around a sum of the frequency of the local signal and a frequency of the clock signal, and a component around a difference between the frequency of the local signal and the frequency of the clock signal.

11. The wireless communication apparatus of claim 9, wherein the transmission path specifying processing is performed once using the local signal having an arbitrary frequency.

12. The wireless communication apparatus of claim 1, wherein
each of the transmission paths comprises:
an input buffer configured to buffer and output the clock signal;
a wire configured to transmit an output signal of the input buffer; and
an output buffer configured to buffer and output the signal transmitted through the wire, and
the control unit is configured to activate the input buffer and the output buffer of the selected transmission path, and not to activate the input buffer and the output buffer of the transmission path which is not selected.

13. The wireless communication apparatus of claim 1, wherein
each of the transmission paths comprises:
an input switch, the clock signal being supplied to one end of the input switch;
a wire, one end of the wire being connected to the other end of the input switch; and
an output switch, one end of the output switch being connected to the other end of the wire, and the other end of the output switch outputting the clock signal transmitted through the wire during conduction, and
the control unit is configured to conduct the input switch and the output switch of the selected transmission path, and not to conduct the input switch and the output switch of the transmission path which is not selected.

14. A wireless communication apparatus comprising:
a receiving unit configured to receive a reception signal;
a clock adjusting unit configured to generate an adjusted clock signal obtained by adjusting a rising time and a falling time of a supplied clock signal to a time represented by a reciprocal of a predetermined frequency; and
a function circuit configured to operate in synchronization with the adjusted clock signal,
wherein the predetermined frequency is equal to a frequency of the reception signal or close to the frequency of the reception signal.

15. The wireless communication apparatus of claim 14, wherein
the function circuit is a local signal generating unit configured to generate a local signal based on the adjusted clock signal,
the receiving unit is configured to receive the reception signal having a frequency corresponding to a frequency of the local signal, and
the wireless communication apparatus further comprises a control unit configured to control the local signal generating unit to set the frequency of the local signal, and control the clock adjusting unit to set the predetermined frequency equal to the frequency of the local signal.

16. The wireless communication apparatus of claim 14, wherein the predetermined frequency is set as a fixed value near an intermediate frequency between a maximum frequency and a minimum frequency of the reception signal defined according to a wireless communication standard.

17. A wireless communication apparatus comprising:
a receiving unit configured to receive a reception signal;
a clock adjusting unit configured to generate an adjusted clock signal obtained by adjusting at least one of a rising time and a falling time of a supplied clock signal;
a function circuit configured to operate in synchronization with the adjusted clock signal; and
a control unit configured to control the clock adjusting unit such that the rising time and the falling time are different or the rising time and the falling time are equal, according to a frequency of the reception signal.

18. The wireless communication apparatus of claim 17, wherein
the control unit is configured to control the clock adjusting unit such that the rising time and the falling time are different, when an odd order harmonic component of the clock signal overlaps a frequency component of the reception signal, and
control the clock adjusting unit such that the rising time and the falling time are equal, when an even order harmonic component of the clock signal overlaps the frequency component of the reception signal.

19. A wireless communication apparatus comprising:
a receiving unit configured to receive a reception signal;
a function circuit configured to operate in synchronization with a supplied clock signal;
a delay circuit configured to delay the clock signal by adjusting a delay time; and
a correction signal generating circuit configured to adjust an amplitude of a harmonic component of the clock signal to output as a correction signal, the harmonic component being included in the clock signal delayed by the delay circuit, and the harmonic component overlapping a frequency component of the reception signal,
wherein the receiving unit comprises an amplifier configured to amplify the reception signal, and
the correction signal is supplied to an input or an output of the amplifier.

20. The wireless communication apparatus of claim 19, wherein the correction signal generating circuit comprises:
a filter configured to extract the harmonic component of the clock signal from the clock signal delayed by the delay circuit, the harmonic component overlapping the frequency component of the reception signal; and
a variable gain amplifier configured to adjust an amplitude of the harmonic component of the clock signal extracted by the filter to output as the correction signal.
